(19) United States
(12) Patent Application Publication
(10) Pub. No.: US 2016/0028442 A1
(43) Pub. Date: Jan. 28, 2016

(54) PORTABLE WIRELESS SENSOR SYSTEM

(71) Applicant: Aessense Technology Hong Kong Ltd., Harbour City (CN)

(72) Inventor: KENT KERNAHAN, CUPERTINO, CA (US)

(21) Appl. No.: 14/341,774

(22) Filed: Jul. 26, 2014

(51) Int. Cl. H04B 5/00

(52) U.S. Cl. CPC H04B 5/0037; H04B 5/0081

(57) ABSTRACT

A removable device rests within a fixed device for the purpose of providing sensor data and/or communications capability to the fixed device. The removable device has no power source of its own, instead receiving power from a collar affixed to the fixed device with a pair of coils in proximate locations. Another pair of coils provides data between the two. The fixed device is permanently serialized so that a supervisory system may associate communications from the removable device with a certain fixed device.

### BACKGROUND

Many electrical, mechanical, chemical, aqueous, and other systems require sensors for their operation. These sensors may provide data, sometimes a digital version, of the quantities sensed. The sensed quantities come in a huge variety, for example temperature, pressure, acidity, position, rotational or liner rate, rate of change, pressure, color, luminosity; the list is virtually limitless. Often times the designer of a system which requires one or more sensors designs at least an electrical interface to the control system, often a mechanical interface or coupling, a case, and perhaps a power supply.

The burden of designing a system from scratch may be reduced by assembling standard products and using existing communications technologies. This method may still require expensive customization and/or understanding protocols that are familiar to others but new to the designer. The resulting design may also be physically larger than desired and need tooling for an enclosure.

What is needed is a system whereby a variety of sensors or communications devices, which are an easily understood and implemented suite of sensors or communications devices, may be used in a system design with a minimum of tooling and programming.

### SUMMARY

The present disclosure describes a system denominated a “WAND”, an acronym for Water, Air, Network Device. The WAND may be provisioned with a variety of sensors according to the system designer's needs, housed in a limited number of form factors. The WAND may be completely devoid of internal power, instead be inserted into a collar wherein the collar induces power into the WAND. Such an arrangement enables a system to be built and used wherein the WAND is easily removable for a variety of reasons. With standardized form factors for the WAND and collar, end products may be designed to have optional features, implemented by what WAND is selected for use, then possibly upgraded, etc, by merely swapping in a WAND with different features. This configuration also provides for fast, low labor cost maintenance.

The use of connectorless power transfer and communications improves the WAND System's immunity to harsh, corrosive environments.

WANDS may be configured with wireless communications capability, thereby acting as a gateway. Wired communications are sometimes synthesized by inductively communicating between the WAND and the collar, the collar in turn connected to other devices by any means.

### BRIEF DESCRIPTION OF THE DRAWINGS

The accompanying drawings, which are incorporated herein and constitute part of this specification, illustrate exemplary aspects of the invention, and, together with the general description given above and the detailed description given below, serve to explain features of the invention.

FIG. 1 is a top level schematic showing how the various subsystems of an exemplary system may be electrically connected.

FIG. 2 details an exemplary wireless power system.

FIG. 3 details an electronic subsystem including Wi-Fi capability.

FIG. 4 is an air-based sensor subsystem.

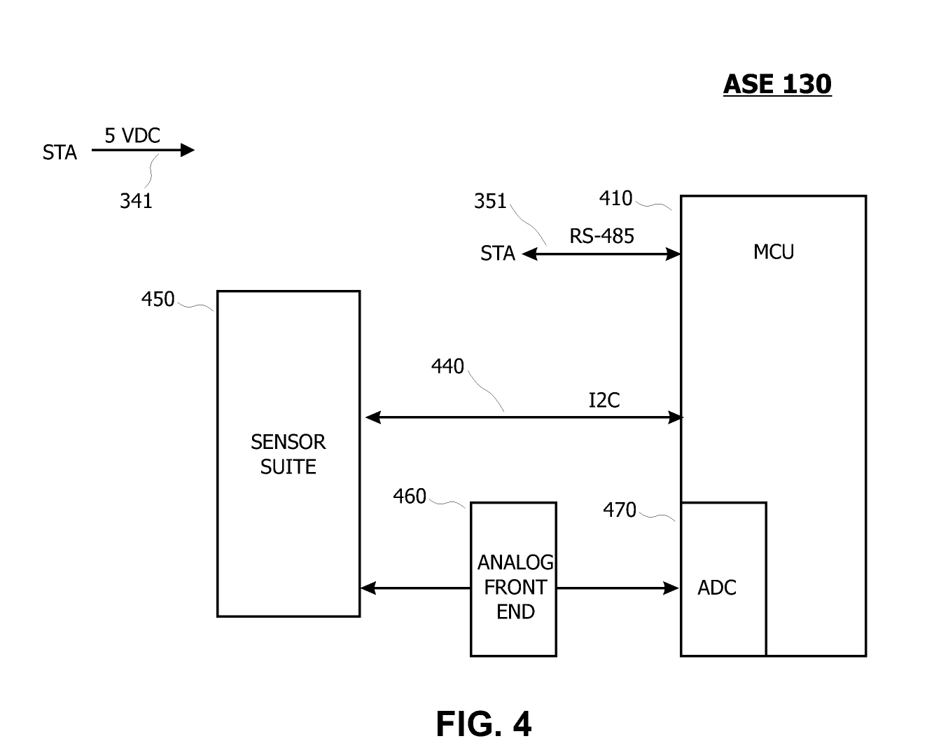

FIG. 5 is a water-based subsystem.

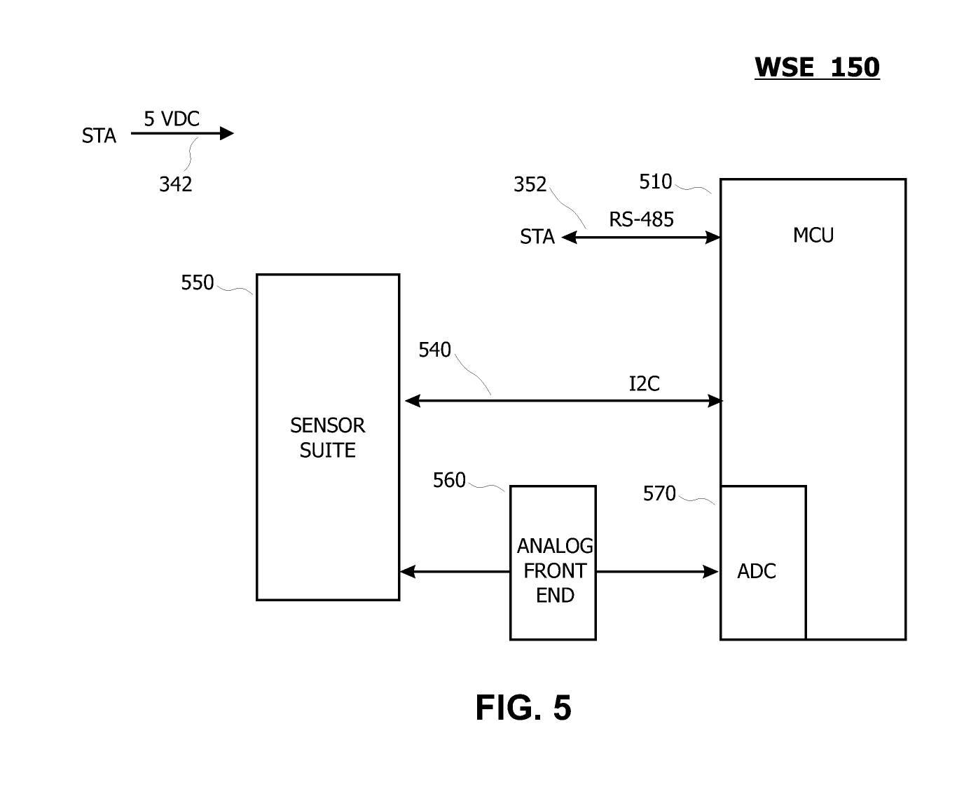

FIG. 6 is an H-field communications subsystem for a portable unit.

FIG. 7 is an H-field communications system for a power and data collar.

FIG. 8 is an exemplary external load.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The variety of devices available for implementation of a WAND and collar system make it impractical to describe all possibilities in a disclosure. A WAND system may include many sensors, one sensor, or even no sensors within the scope of the present disclosure. Absent any sensors a WAND may be useful as a control and/or communications device, for example as an access point, repeater, gateway, or bridge between two different communications technologies.

By way of example, a WAND for providing sensor and communications for an aeroponic growth system will be presented. One of ordinary skill in the related arts will appreciate the generality of the disclosure and know how different implementations may be designed. All such are within the scope of this disclosure and claims.

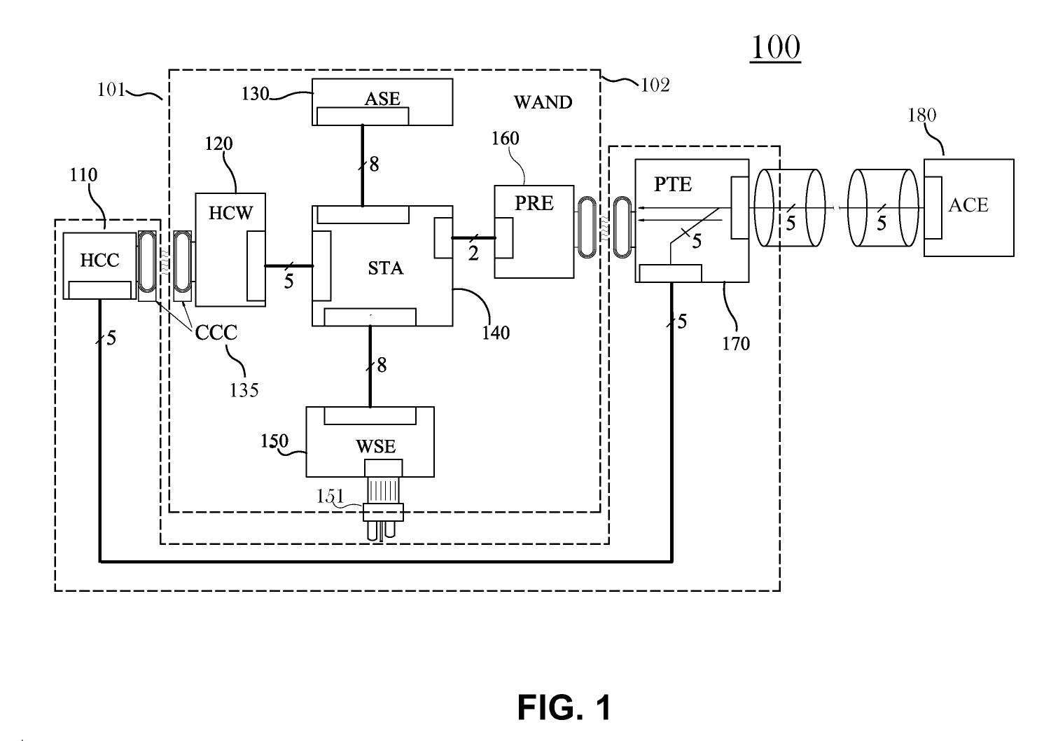

Looking to FIG. 1, an exemplary WAND and collar system 100 comprises a WAND 101 and a collar 102, customized for an exemplary aeroponic growth system. The WAND 101 comprises an HCW 120 (H-field Communications-WAND), an ASE 130 (Air Sensor Electronics), an STA 140 (WAND Station Board), a WSE 150 (Water Sensor Electronics) and a PRE 160 (Power Receiver Electronics). The collar 102 comprises an HCC 110 (H-Field Communications-Collar), and a PTE 170 (Power Transmitter Electronics). In the example of FIG. 1 the PTE 170 passes through power, ground, and data lines to an ACE 180 (Atrium Chamber Electronics). The ACE 180 is not strictly speaking a part of the WAND and collar system 100 in that it is an arbitrary external system selected for the purpose of illustration.

The major example blocks will be described in detail. In some instances component part numbers may be stated. All components are commercial off-the-shelf (COTS); most are available from major distributors such as DIGIKEY.COM.

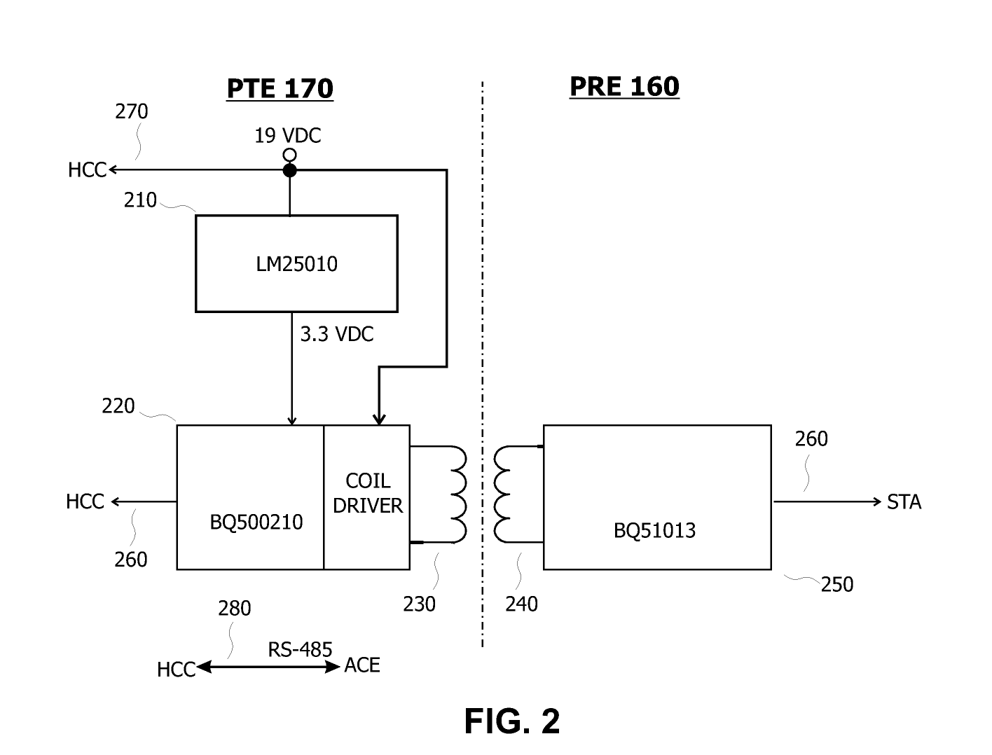

The PTE 170 may be implemented in a variety of ways. The PTE in the exemplary design provides power to the PRE 160 inside the WAND 101, where it is distributed internally to WAND electronics assemblies HCW 120, ASE 130, STA 140, and WSE 150. Referring to FIG. 2, we see the PTE 170 coupled to the PRE 160 for power transfer from the collar to the WAND. In the PTE 170 a regulator such as an LM25010 210 receives 19 VDC from an external supply. The regulator 210 provides a 3.3 VDC output, which powers the PTE 170 board on a line 275. A second path routes the 19 VDC input supply to the HCC 110. The 3.3 VDC is also provided to a Texas Instruments P/N BQ500210 “Qi Compliant Wireless Power Transmitter Manager” 220. The manager 220 provides a PWM drive signal to a high speed driver, for example a Texas Instruments TPS28225, which in turn drives a Wurth Wireless Power Charging Transmitter Coil 230 P/N 760368110, using the 19 VDC supply. The transmitting coil 230 is located approximate to a receiving coil 240 TDK P/N WR-483250, which is electrically connected to a Texas Instruments BQ51013 Wireless Power Receiver 250 in the PRE 160. The 5.0 VDC output of the power receiver 250 is provided to the STA 140 on a line 260.

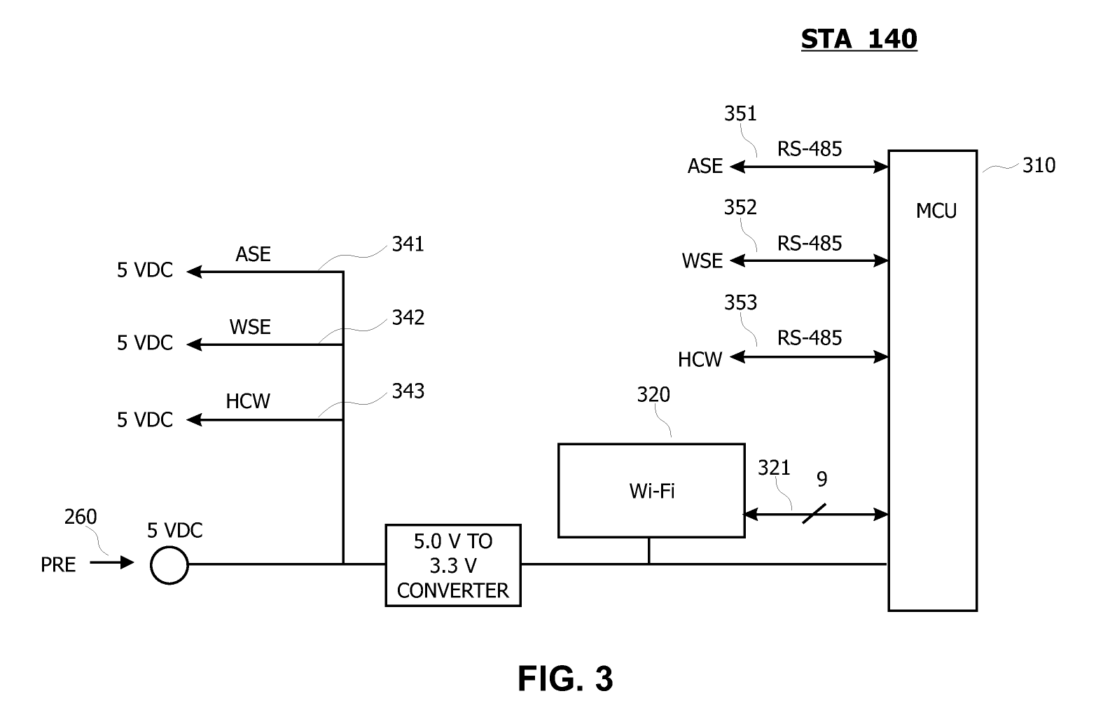

Looking to FIG. 3, 5.0 VDC power received by STA 140 from the PRE 160 on a line 260 is further provided directly to the HCW 120 on a line 343, WSE 150 on a line 342 , and ASE 130 on a line 341. 5.0 VDC power is converted to 3.3 VDC and provided to a Wi-Fi unit 320, for example a Microchip MRF24WGOMA. The Wi-Fi 320 responds to data and commands provided by an MCU 310, for example a Microchip PIC32MX695F512L via a nine-line bus 321. The STA 140 may also include RS-485 communications capability between the MCU 310 and the ASE 130 on a line 351, WSE 150 on a line 352, and HCW 120 on a line 353.

STA 140 may connect to ASE 130 which may support a suite of air sensors. In addition to power and ground on the line 341, the STA may have an RS-484 wired communications bus for two-way communication on the bus 351. The ASE 130 may include a suite of air sensors, collectively numerated 450. Examples of air sensors 450 include sensors for CO2, CO, O2 and ambient light. Some embodiments may include am MCU 410, for example PIC32MX350F256H, wherein the MCU 420 includes an analog to digital converter 470 (ADC). Some embodiments include a MUX or analog front end 460. Some MCUs 410 may have enough analog input pins instead of an external MUX 460. The MCU 410 may manage the sensors, for example powering them up or down, standby or operative mode, determining status, and diagnostics. The MCU 410 may also be programmed to receive requests for data related to a given sensor, providing the data back to the STA board 140 via the RS-485 bus 420. The STA may then provide the data to the requester via the 320 Wi-Fi or other data link.

The WSE 150 may be very similar to the ASE 130. The WSE 150 may receive DC power from STA 140 on the line 342 and may also send and receive data on an RS-485 wired communications bus 352. In the example shown, the WSE 150 may comprise a suite of water sensors 550, wherein the sensors 550 are submerged in a water medium. Examples of sensors 550 include pH, temperature, total dissolved solids (TDS), and resistivity. In some embodiments an MCU 510, for example a PIC32MX350F256H, wherein the MCU 510 includes an analog to digital converter 570 (ADC). Some embodiments include a MUX or analog front end 560. Some MCUs 510 may have enough analog input pins instead of an external MUX 560. The MCU 510 may manage the sensors, for example powering them up or down, standby or operative mode, determining status, and diagnostics. The MCU 510 may also be programmed to receive requests for data related to a given sensor, providing the data back to the STA board 140 via the RS-485 bus 520. The STA may then provide the data to the requester via the 320 Wi-Fi or other data link.

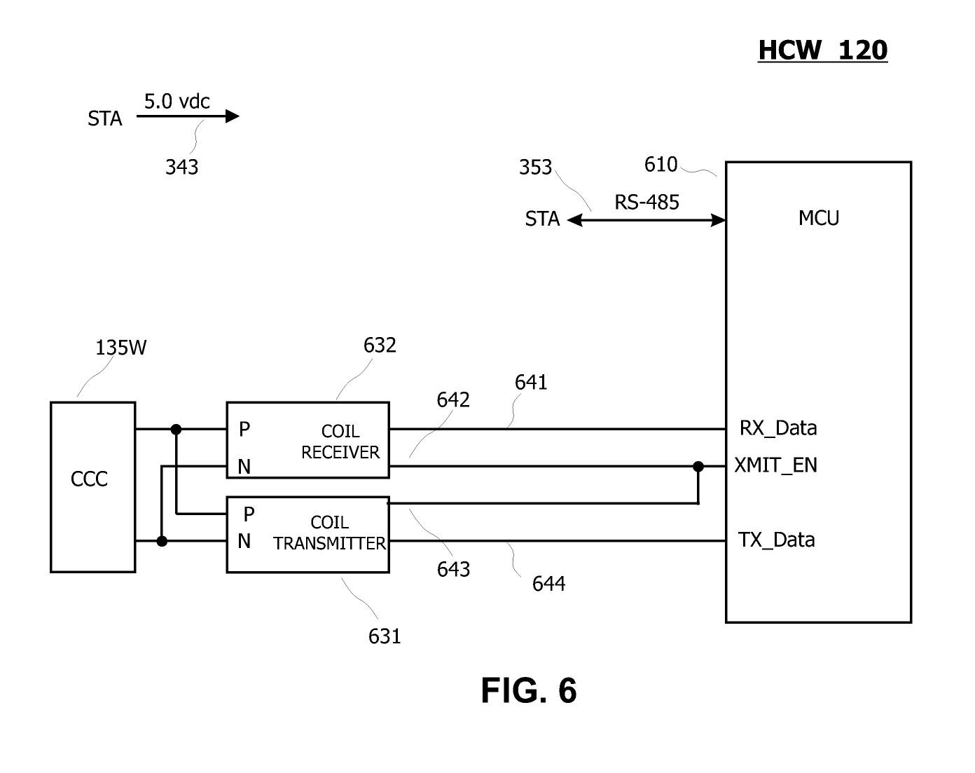

Looking to FIG. 6, the HCW 120/HCC 110 pair operate very much as do the PTE 170/PRE 160, except data is exchanged between the transmitting and receiving coil rather than power. The HCW 120 receives 5.0 VDC power from STA on the line 343. An MCU 610, for example a Microchip PIC32MX350F128D, may communicate with the STA 140 via the RS-485 bus 353. The MCU 610 receives data on a line 641 and sends data on a line 644. Data activity is controlled by an XMIT_EN signal on a line 642, 643. The signals connect the MCU 610 to a coil transmitter 631 and a coil receiver 632. The P and N signals from the coil transmitter 631 and the coil receiver, connected as shown, drive a CCC 135W. The CCC 135W coil and a matching (may be identical) coil CCC 135C on the HCC 110, the pair of coils being proximate to enable inductively passing data signals. An example of the CCC 135 coil is a TDK WR-483250-15M2-G.

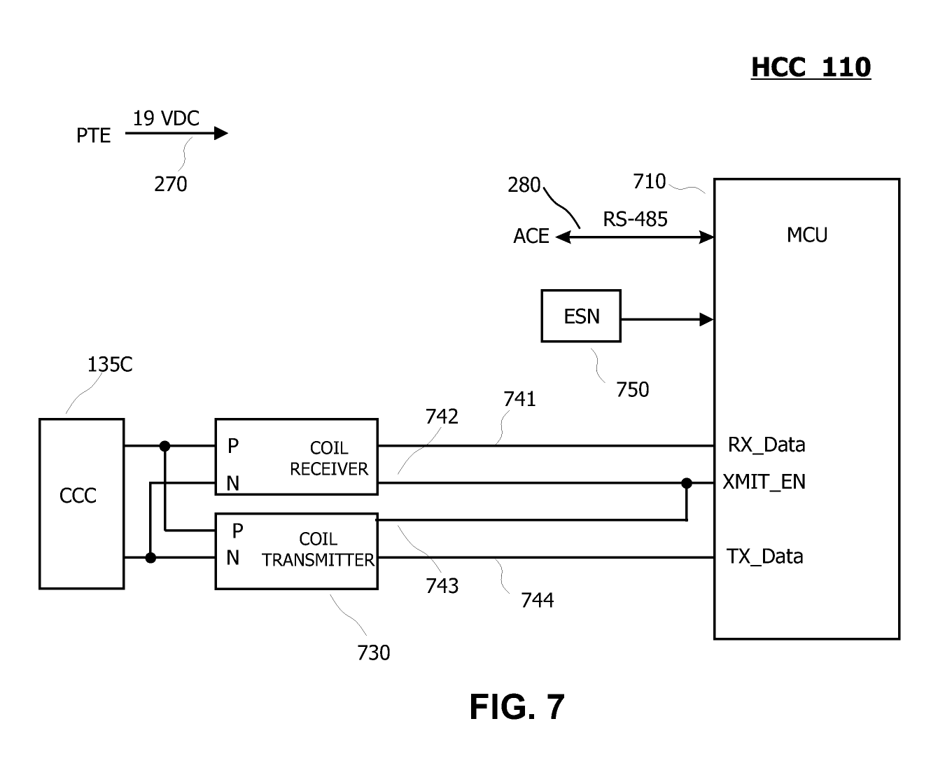

Looking now to FIG. 7, the HCC 110 receives 19 VDC power on a line 270 from the PTE 170. Except for operating voltage, the HCW 120 and HCC 110 are very similar in operation.

An MCU 710, for example a Microchip PIC32MX350F128D, may communicate with the ACE 180 via the RS-485 bus 280, which may be a pass-through in the PTE 170. The MCU 710 receives data on a line 741 and sends data on a line 744. Data activity is controlled by an XMIT_EN signal on a line 742, 743. The signals connect the MCU 710 to a coil transmitter 731 and a coil receiver 732. The P and N signals from the coil transmitter 731 and the coil receiver, connected as shown, drive a CCC 135C.

The HCC 110 includes an ESN (electronic serial number) 750, for example a Maxim Integrated DS2411. The WAND and collar system 100 may be used to provide sensors and communications capability to a fixed piece of equipment. A given WAND's 101 technology content, such as sensor suite, may be known by its manufacturer's product model number. As such, all WANDs 101 bearing the instant model number are expected to be the same. That is, the WANDs would be freely interchangeable. However the fixed equipment may be one of an unlimited number of otherwise identical units, and a supervisory system would need to know from which fixed piece of equipment data is being sent to or received from a WAND 101. The number in an ESN is deemed to be unique, and known to the supervisory system. In some embodiments the WAND 101 may be paired to a certain piece of fixed equipment by interrogating the HCC 110 through the CCC 135 communications link and asking the MCU 710 to report the serial number stored in its ESN 750.

As mentioned hereinbefore, there may be electronics in the equipment including the collar 102. By way of example, we look at an ACE 180, an exemplary system within an aeroponic growth system. The ACE may be designed to make use of the water sensors of the WSE 150 and/or air sensors ASE 130. In addition the WAND 101 may provide communications capability via the Wi-Fi instantiated within the STA 140 subsystem of the WAND 101. The communications may be for the purpose of providing data to an external system or receiving commands from an external system. One of ordinary skill in the art will know of many other purposes, depending upon the fixed equipment and its purpose.

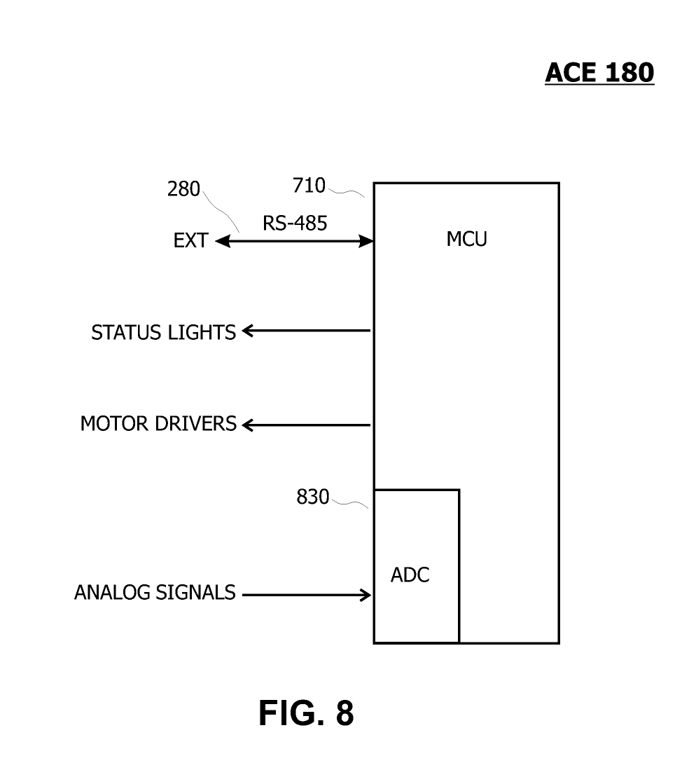

Per FIG. 8, an ACE 180 may communicate with the WAND 101 via the HCC 110 on an RS-485 bus 280. This and other signals may be passed through to the ACE 180 by the PTE 170, and power and other signals may be passed to the PTE 170 by the ACE 180. The ACE 180 may include an MCU 810, which includes a number of general purpose input/output (GPIO) pins 820. Some systems may include an ADC 830 to provide a digital version of analog signals connected to the ADC 830. In an aeroponic system the MCU 810 may provide signals to turn fans ON or OFF, as well as motor drivers, relays, and the like. In one embodiment the ACE 180 includes a variety of colored lights, wherein the MCU 810 may turn on a light of an appropriate color, for example green, yellow, or red and optionally a noise-producing device to provide a quick and easy status value to an observer. In some embodiments it is the ACE 180, likely being connected to grid power, which provides the 19 VDC input to the PTE 170.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A wireless system gateway, comprising:
a removable WAND unit comprising a wireless communication device;
a collar for holding the WAND, wherein the WAND and the collar each have coils proximate to each other electronically coupled for providing power to the WAND and the exchange of data signals between the WAND and the collar.
